(19) United States
(12) Patent Application Publication
(10) Pub. No.: US 2019/0027034 A1
(43) Pub. Date: Jan. 24, 2019

(54) VARIABLE STEERING ERROR LIMITS FOR AUTOMATED VEHICLE CONTROL

(71) Applicant: Aptiv Technologies Limited, St. Michael (BB)

(72) Inventors: Wenda Xu, Pittsburgh, PA (US); Junqing Wei, Brigdeville, PA (US)

(21) Appl. No.: 15/653,879

(22) Filed: Jul. 19, 2017

(51) Int. Cl. G08G 1/0967; G06K 9/00; B62D 15/02

(52) U.S. Cl. CPC G08G 1/096725; G01C 21/26; B62D 15/025; G06K 9/00805

(57) ABSTRACT

A system for semi-autonomous, or autonomous, operation of a host vehicle includes an object detector and a controller. The object detector is configured to detect an object proximate to a lane boundary and output an object signal. The controller is configured to process the object signal and direct the host vehicle away from the lane boundary upon detection of the object.

### BACKGROUND

The operation of modern vehicles is becoming increasingly autonomous, causing a decrease in driver intervention. A control feature of such modern vehicles may cause the vehicle to drive in the center of a lane regardless of the existence of objects to the left or right of the lane. One example of such an object may be a vehicle parked at the side of the road, although outside of the lane. For the vehicle to remain at the center of the lane, the vehicle may pass the object closely.

### SUMMARY

In one, non-limiting, exemplary embodiment of the present disclosure, a system for semi-autonomous or autonomous operation of a host vehicle includes an object detector and a controller. The object detector is configured to detect an object proximate to a lane boundary and output an object signal. The controller is configured to process the object signal and direct the host vehicle away from the lane boundary upon detection of the object.

In another, non-limiting, embodiment, an autonomous vehicle includes a controller and a steering unit. The controller includes a processor and an electronic storage medium. The steering unit is constructed and arranged to receive a steering command from the controller for moving the autonomous vehicle from a centered position to a biased position upon receipt of an object detected signal.

In another, non-limiting, embodiment, a computer software product is executed by a controller of an automated vehicle configured to receive object and lane positioning signals to control lane positioning of the automated vehicle based on the detection of an object proximate to a lane boundary. The computer software product includes an object module and a lane positioning module. The object module is configured to receive the object signal and determine if the object is proximate to the lane boundary. The lane positioning module configured to receive the lane positioning signal to determine lane positioning of the automated vehicle, and at least in-part effectuate movement of the automated vehicle from a centered position to a biased position that is away from the lane boundary if the object module determines that the object is proximate to the lane boundary.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a top view of a multi-lane roadway traveled by an automated vehicle equipped with a system to detect an object proximate to a lane boundary in accordance with the present invention; and

FIG. 2 is a schematic of the automated vehicle with the system in accordance with the invention.

### DETAILED DESCRIPTION

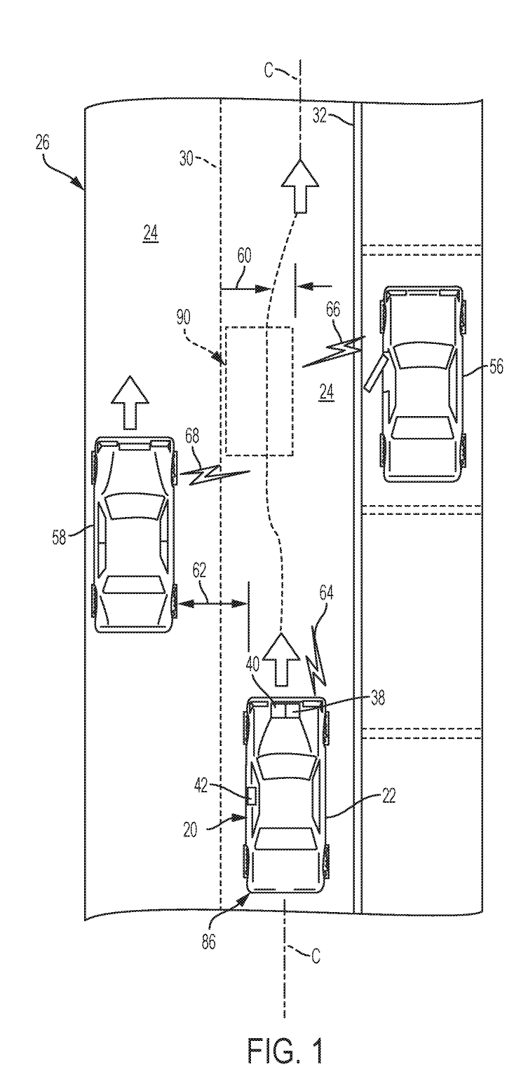

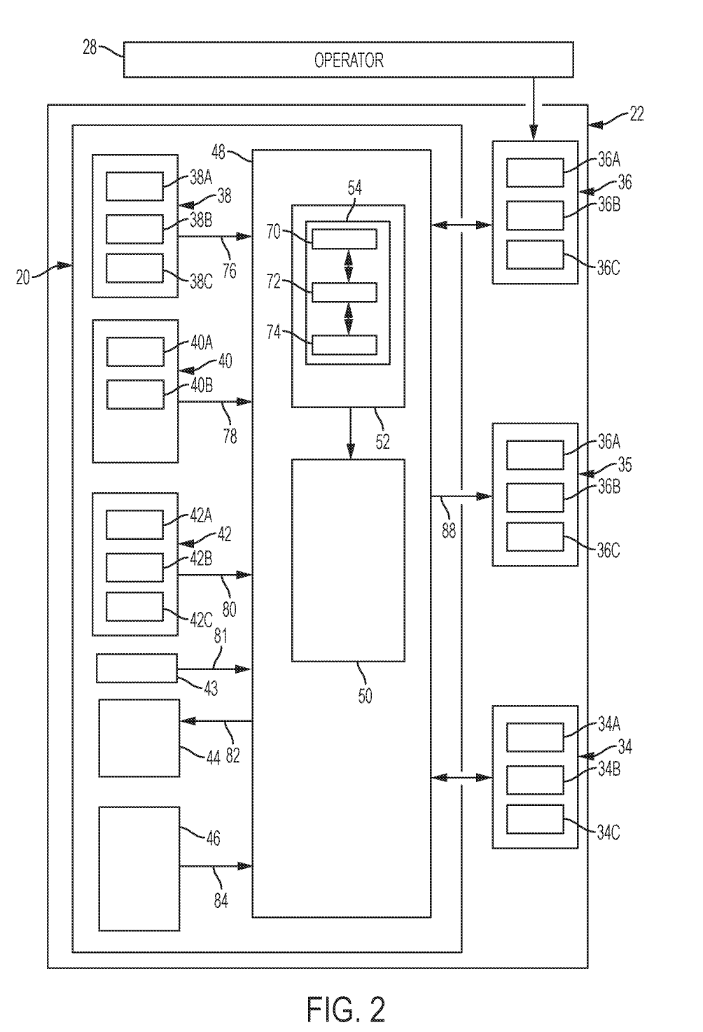

FIG. 1 illustrates a non-limiting example of a variable steering error limit system, hereafter the system 20, for semi-autonomous, or autonomous operation of a host vehicle 22. The host vehicle 22 may be a fully automated vehicle (i.e., autonomous vehicle). As part of a fully automated vehicle, the system 20 may control the speed, direction (e.g., steering), brakes, and other aspects of the host vehicle operation necessary for the host vehicle 22 to travel in a lane 24 of a roadway 26 without interaction from an occupant, or operator 28 (see FIG. 2) situated within the host vehicle 22. The roadway 26 may have multiple lanes 24 with the lanes being defined between two lane boundaries 30, 32. The lane boundaries 30, 32 may be represented by painted markings on the roadway 26, by curbs, or by a combination of both.

Referring to FIGS. 1 and 2, and in another application, the host vehicle 22 may be driven by the operator 28. In this case, the system 20 may provide assistance to the operator 28 (i.e., a semi-autonomous vehicle). This assistance may be the mere activation of a warning-device 34, or may include activating a control override unit 35 that temporarily takes over the control of manual controls 36 that are used by the operator 28 and/or the system 20. Such manual controls 36 may include a directional unit 36A (e.g., steering unit), an acceleration unit 36B, and a braking unit 36C of the host vehicle 22. The warning device 34 may include, or may be, an audible device 34A, a visual device 34B, and/or a haptic device 34C.

The system 20 may include the warning device 34, the control override unit 35, the manual controls 36, an object detector 38, a lane positioning detector 40, an adjacent vehicle detector 42, a vehicle speed sensor 43, a vehicle-to-vehicle (V2V) transmitter 44, a V2V receiver 46, and a controller 48. The controller 48 may include a processor 50 and an electronic storage medium 52. The processor 50 may be a microprocessor or other control circuitry such as analog and/or digital control circuitry including an application specific integrated circuit (ASIC) for processing data as is known by one with skill in the art. The storage medium 52 of the controller 48 may be non-volatile memory, such as electrically erasable programmable read-only memory (EEPROM) for storing one or more routines, thresholds, and captured data, hereafter referred to as an application 54 (i.e., the computer software product). The application 54 may be executed by the processor 50 of the controller 48 to perform steps for determining if various signals received from one or more of the detectors 38, 40, 42 indicate that an object exists, the object is being approached by the host vehicle 22, and whether the host vehicle 22 should be in the center of the lane 24, a biased position, or some other position.

The object detector 38 of the system 20 is configured to detect an object 56 that may be located outside of the lane 24 that the host vehicle 22 is traveling on, and proximate to one of the two defining boundaries 30, 32. The object 56 may be initially forward of the host vehicle 22, may be stationary, may be moving at a speed slower than the host vehicle 22, or may be moving at a speed in a different direction than the host vehicle. Although the object 56 is illustrated as a parked vehicle, other non-limiting examples may include a guard rail, traffic cones, a person, and others.

The object detector 38 may be, but is not limited to, one or more of a Light Detection and Ranging (LiDAR) device 38A, a radar device 38B, and/or an image capture device or camera 38C. Other devices suitable to detect an approaching object 56 such as a microphone and an ultrasonic transceiver are also contemplated. It is contemplated that two or more of these devices 38A, 38B, 38C may cooperate to detect and classify the approaching object 56 while the host vehicle 22 is moving. For example, information from the radar device 38B and the camera 38C may be combined to reliably detect the object 56 ahead of the host vehicle 22. In one embodiment, the LiDAR device 38A may be preferable for determining that the object 56 ahead of the host vehicle 22 is, for example, a parked vehicle or a pedestrian standing proximate to the lane boundary 30. However, advancements in radar and image processing of images captured by the camera 38C are expected, so those devices may be preferable in the future.

While the object detector 38 is illustrated as being mounted at the front of the host vehicle 22, it is contemplated that the various devices 38A, 38B, 38C may be distributed and/or duplicated at various location about the host vehicle 22. for example, the camera 38C, or duplicates of the camera, may be located rearward on the host vehicle 22 so that the lane boundaries 30, 32, and other boundaries of the roadway 26 can be detected. Similarly, the radar device 38B, or duplicates of the radar device, may be mounted at each corner of the host vehicle 22 so that, in addition to detecting the object 56, an adjacent vehicle 58 in an adjacent lane 24 of the roadway 26 may be detected.

The lane positioning detector 40 of the system 20 is configured to determine a relative position (see arrow 60 in FIG. 1) of the host vehicle 22 in the lane 24 with respect to a lane centerline C, the boundaries 30, 32, or other markings/features of the roadway 26. The lane positioning detector 40 may be, or may include, an image capture device or camera 40A, a geographic navigation device 40B (e.g., global positioning system (GPS), and/or other devices configured to determine the vehicle position within the lane 24. The lane positioning detector 40 is shown mounted at the front of the host vehicle 22, but other locations such as on the roof of the host vehicle 22, or within the occupant compartment and looking through the windshield of the host vehicle 22 are also contemplated.

The adjacent vehicle detector 42 of the system 20 is configured to determine a distance (see arrow 62 in FIG. 1), which may be a lateral distance, measured between the adjacent vehicle 58 and the host vehicle 22. The adjacent vehicle detector 42 may include, but is not limited to, one or more of a LiDAR device 42A, a radar device 42B, and/or an image capture device or camera 42C. Other devices suitable to detect an adjacent vehicle such as a microphone and an ultrasonic transceiver are also contemplated. It is contemplated that two or more of these devices 42A, 42B, 42C may cooperate to detect and classify the adjacent vehicle 58 and measure distance 62 while the host vehicle 22 is moving. For example, information from the radar device 42B and the camera 42C may be combined to reliably detect the adjacent vehicle 58 and/or measure distance 62 ahead of the host vehicle 22. In one embodiment, the LiDAR device 42A may be preferable for determining that the adjacent vehicle 58 ahead of the host vehicle 22. However, advancements in radar and image processing of images captured by the camera 42C are expected, so those devices may be preferable in the future.

While the adjacent vehicle detector 42 is illustrated as being mounted at the side of the host vehicle 22, it is contemplated that the various devices 42A, 42B, 42C may be distributed and/or duplicated at various locations about the host vehicle 22. For example, the camera 42C, or duplicates of the camera, may be located rearward on the host vehicle 22 so that approaching adjacent vehicles 58 may be detected. Similarly, the radar device 42B, or duplicates of the radar device, may be mounted at each corner of the host vehicle 22 so that, in addition to detecting the adjacent vehicle 58, objects 56 adjacent to the roadway 26 may be detected. It is contemplated and understood that the detectors 38, 40, 42 may share various devices. For example, the camera 38C may be, or may be capable of functioning as, the camera 42C. Furthermore, if one camera should fail, the camera of another detector may be used by the system 20 instead.

The V2V transmitter 44 may be configured to transmit a host signal 64 that may generally indicate a particular position of the host vehicle 22 with the lane 24. The V2V transmitter 44 may be, but is not limited to, a Dedicated Short Range Communications (DSRC) system that uses the known 802.11P communications protocol. The V2V receiver 46 may be configured to receive an object signal 66 from the object 56 that may, for example, indicate the object (i.e., in the example of a vehicle) is parked. The object signal 66 may also include GPS data or other location data that when received by the controller 48 of the system 20, provide further information pertaining to the distance between the host vehicle 22 and the object 56. The V2V receiver may also be configured to receive an adjacent vehicle signal 68 from the adjacent vehicle 58 that may indicate the adjacent vehicle 58 is in a particular position relative to the lane 24 that the adjacent vehicle is traveling in.

The application 54, which may be stored in the electronic storage medium 52 of the controller 48, may include an object module 70, a lane positioning module 72, and an adjacent vehicle module 74. The object detector 38 is configured to output an object signal 76 for processing by at least the object module 70. The lane positioning detector 40 is configured to output a lane positioning signal 78 for processing by at least the lane positioning module 72. The adjacent vehicle detector 42 is configured to output an adjacent vehicle signal 80 for processing by at least the adjacent vehicle module 74. The speed sensor 43 is configured to send a speed signal 81 to the controller 48 for processing by at least the adjacent vehicle module 74 to generally determine the initiation and rate of a vehicle position shift within the lane 24. The transmitter 44 is configured to receive a transmit command 82 from the controller 48 that commands the transmitter 44 to transmit the host signal 64 (see FIG. 1) indicative of the host vehicle 22 being in a particular position with respect to the lane boundaries 30, 32. The receiver 46 is configured to receive various, external, signals, such as the object signal 66 and the adjacent vehicle signal 68, and send a receiver signal 84, indicative of at least signals 66, 68, to the controller 48 for processing.

In operation of the system 20, and in one scenario where the object detector 38 does not detect the object 56, the object detector 38 may send an object signal 76, indicative of ‘no object detected’, to the controller 48 for utilization by the object module 70 of the application 54. Simultaneously, the lane positioning detector 40 may be sending a lane positioning signal 78 to the controller 48 for utilization by the lane positioning module 72 of the application 54. If the lane positioning signal 78 is indicative of the host vehicle 22 being in a centered position 86 (i.e., centered to centerline C or centered within the lane 24, see FIG. 1), the lane positioning module 72, executed in unison with the object module 70, may cause the host vehicle 22 to remain in the centered position 86. If the host vehicle 22 is not in the centered position 86, the positioning module 72 may cause the controller 48 to initiate a command signal 88 to the directional unit 36A directing the host vehicle 22 to adjust toward the centered position 86 while moving in a forward direction. In one embodiment, the host vehicle 22 may remain centered to the lane 24 even when the adjacent vehicle detector 42 sends an adjacent vehicle signal 80 to the adjacent vehicle module 74 indicating an adjacent vehicle 58 is in the adjacent lane 24.

In another operating scenario, the object detector 38 may detect an object 56, thus may send an object signal 76, indicative of at least ‘an upcoming object detected’, to the controller 48 for utilization by the object module 70 of the application 54. Simultaneously, the lane positioning detector 40 may be sending a lane positioning signal 78 to the controller 48 for utilization by the lane positioning module 72 of the application 54. If the lane positioning signal 78 is indicative of the host vehicle 22 being in the centered position 86, the lane positioning module 72, executed in unison with the object module 70, may direct the controller 48 to send a command signal 88 to the directional unit 36A directing the host vehicle 22 to adjust toward a biased position 90 (see FIG. 1). This will cause the host vehicle 22 to shift away from the object 56, thereby increasing the clearance between the object 56 and the passing host vehicle 22. More specifically, if the object 56 is detected as being proximate to the lane boundary 32, the biased position 90 will amount to a host vehicle shift toward the opposite lane boundary 30, and vice-versa.

When the object detector 38 detects an object 56 ahead of the host vehicle 22 and that object is determined to be within a prescribed distance from the lane boundary 32, or it is determined that the host vehicle 22 will pass within a minimum threshold distance from the object 56, the system 20 may place the host vehicle 22 in the biased position 90 (i.e. offset position) generally at the moment the host vehicle 22 passes the object 56. In this way, the system 20 creates a safe and/or comfortable distance between the host vehicle 22 and the object 56 at the moment of passing. Also, the lane positioning detector 40 provides the necessary data to the application 54 to assure this additional clearance is maintained while passing the object 56. That is, the lane positioning module 72 with the real-time data collected by the lane positioning detector 40, verifies that the host vehicle 22 is in the biased position 90. In one example, this clearance may be about one meter (1m). In another example, the clearance may be a function of the width of the host vehicle 22 and a width of the lane 24.

In one example, the lane positioning detector 40, or another detector, may detect a forward distance between the detected object 56 and the forward moving host vehicle 22. This forward distance along with the velocity of the host vehicle obtained from the speed signal 81 may be utilized by the lane positioning module 72 to determine when the movement from the centered position 86 to the biased position 90 should be initiated. This same data may also be used to determine the rate at which the host vehicle 22 moves from the centered position 86 to the biased position 90.

The additional clearance created between the object 56 and the host vehicle 22 may be in anticipation of the object 56 inadvertently moving into or toward the lane 24. For example, the application 54 executed by the processor 50 of the controller 48 may determine that the object 56, via for example one of the cameras 38C, 42C is a parked vehicle. As a parked vehicle, and by providing the additional clearance, the host vehicle 22 is anticipating that a driver of the parked vehicle may open a door into the lane 24 without taking proper precautions. In another example, the object 56 may be a person standing at, or besides, the lane boundary 32 that may be a curb.

Continuing the operating scenario, with the host vehicle 22 shifting toward the biased position 90, or being in the biased position 90, the controller 48 may send a command 82 to the transmitter 44 directing the transmitter to transmit a signal 64 indicative of the host vehicle 22 being in the biased position 90. The signal 64 may be received by the adjacent vehicle 58, if autonomous, causing the adjacent vehicle to also shift lane position.

Also during operation of the system 20, the V2V receiver 46 may be configured to receive the object signal 66 from the object 56. In an example where the object 56 includes GPS capability, the object signal 66 may include data indicating the position of the object relative to the roadway 26. Furthermore, the V2V receiver 46 may also be configured to receive an adjacent vehicle signal 68 from the adjacent vehicle 58 indicating that the adjacent vehicle 58 is in, or is going to enter into, a biased position 90.

In yet another embodiment, and when the object 56 is detected and the host vehicle 22 is in the centered position 86, the land positioning module 72 may switch from a first set of left and right error limits to a second set of left and right error limits. All of the error limits may be pre-programmed into the controller 48. The left and right error limits of the first set may be substantially equivalent to one-another. With the error limits equivalent, the host vehicle 22 may be held substantially at the centered position 86. In contrast, the left and right error limits of the second set may not be equivalent to one-another. When the second set is applied, the host vehicle adjusts, or shifts, toward the biased position 90. More specifically, if the object 56 is detected at the left boundary 32, the second set of left and right error limits applied may have a right error limit that is larger than a left error limit. In this embodiment, a ‘direct’ command to move from the centered position 86 to the biased position 90 need not be sent from the controller 48 to the directional unit 36A.

Accordingly, the system 20 for automated operation of the host vehicle 22 advances the automated vehicle arts by enabling a system, application, or controller to determine when a host vehicle should move from a centered position 86 within a lane 24 to a biased or off-centered position 90 to create a comfortable distance between an object 56 that may be stationary and the host vehicle 22.

The various functions described above may be implemented or supported by a computer program that is formed from computer readable program codes, and that is embodied in a computer readable medium. Computer readable program codes may include source codes, object codes, executable codes, and others. Computer readable mediums may be any type of media capable of being accessed by a computer, and may include Read Only Memory (ROM), Random Access Memory (RAM), a hard disk drive, a compact disc (CD), a digital video disc (DVD), or other forms.

Terms used herein such as component, application, module, system, and the like are intended to refer to a computer-related entity, either hardware, a combination of hardware and software, or software execution. By way of example, an application may be, but is not limited to, a process running on a processor, a processor, an object, an executable, a thread of execution, a program, and/or a computer. It is understood that an application running on a server and the server, may be a component. One or more applications may reside within a process and/or thread of execution and an application may be localized on one computer and/or distributed between two or more computers

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A system for semi-autonomous or autonomous operation of a host vehicle comprising:
an object detector configured to detect an object proximate to a lane boundary and output an object signal; and
a controller configured to process the object signal and direct the host vehicle away from the lane boundary upon detection of the object.

2. The system set forth in claim 1, further comprising:
a lane positioning detector configured to assist in placing the host vehicle in a centered position when the object detector has not detected the object, and assist in placing the host vehicle in a biased position away from the lane boundary when the object is detected.

3. The system set forth in claim 2, wherein controller is pre-programmed with a first set of left and right of center error limits applied to substantially maintain the host vehicle at a center position when the object is not detected, and a second set of error limits applied to substantially maintain the host vehicle at the biased position when the object is detected.

4. The system set forth in claim 2, further comprising:
a transmitter configured to transmit a signal indicative of the host vehicle moving from the centered position to the biased position for receipt by an adjacent vehicle.

5. The system set forth in claim 4, wherein the transmitter is a Dedicated Short Range Communications (DSRC) system.

6. The system set forth in claim 1, further comprising:
a receiver for receiving an object signal from the object and indicative of an object position.

7. The system set forth in claim 1, wherein the object detector is located at a forward portion of the host vehicle.

8. The system set forth in claim 1, wherein the object detector includes a camera.

9. The system set forth in claim 1, wherein the object detector includes a radar device.

10. The system set forth in claim 1, wherein the object detector includes a LiDAR device.

11. The system set forth in claim 2, wherein the lane positioning detector includes a camera.

12. The system set forth in claim 2, wherein the lane positioning detector includes a geographic navigation device.

13. The system set forth in claim 1, wherein the object is stationary.

14. The system set forth in claim 1, wherein the object is a parked vehicle.

15. An autonomous vehicle comprising:
a controller including a processor and an electronic storage medium; and
a steering unit constructed and arranged to receive a steering command from the controller for moving the autonomous vehicle from a centered position to a biased position upon receipt of an object detected signal.

16. The autonomous vehicle set forth in claim 15, further comprising:
an object detector configured to detect an object proximate to a first lane boundary of a lane upon which the autonomous vehicle is moving, and send the object detected signal to the controller.

17. The autonomous vehicle set forth in claim 16, wherein movement from the centered position to the biased position is away from the first lane boundary.

18. The autonomous vehicle set forth in claim 17, further comprising:
a lane positioning detector configured to detect an autonomous vehicle position with respect to the first lane boundary and an opposite, second, lane boundary, wherein a lane positioning signal is sent from the lane positioning detector to the controller to assist in moving the autonomous vehicle between the centered and biased positions.

19. A computer software product executed by a controller of an automated vehicle configured to receive object and lane positioning signals to control lane positioning of the automated vehicle based on the detection of an object proximate to a lane boundary, the computer software product comprising:
an object module configured to receive the object signal and determine if the object is proximate to the lane boundary; and
a lane positioning module configured to receive the lane positioning signal to determine lane positioning of the automated vehicle, and at least in-part effectuate movement of the automated vehicle from a centered position to a biased position that is away from the lane boundary if the object module determines that the object is proximate to the lane boundary.

20. The computer software product set forth in claim 19, further comprising:
a first set of left and right of center error limits utilized to substantially maintain the host vehicle at the center position when the object is not detected, and a second set of biased left and right error limits utilized to substantially maintain the host vehicle at the biased position when the object is detected.
